(19) United States
(12) Patent Application Publication
(10) Pub. No.: US 2008/0179465 A1
(43) Pub. Date: Jul. 31, 2008

(54) Aircraft With Low Noise, Such as During Take-Off and Landing

(75) Inventor: Christophe Cros, L'Union (FR)

Correspondence Address: STEVENS DAVIS LLP, 1615 L STREET NW, SUITE 850, WASHINGTON, DC, 20036, US

(73) Assignee: AIRBUS FRANCE, TOULOUSE (FR)

(21) Appl. No.: 11/911,604

(22) PCT Filed: Apr. 11, 2006
(86) PCT No.: PCT/FR06/00795

§ 371 Date: Oct. 15, 2007

(30) Foreign Application Priority Data
Apr. 28, 2005 (FR) 05 04281

(51) Int. Cl. B64C 3/10

(52) U.S. Cl. 244/45 R

(57) ABSTRACT

The invention relates to an aircraft with low noise, such as during take-off and landing. According to the invention, the aircraft comprises: two wings (2, 3) which have a reverse sweep (φ) and which do not support an engine; a rear vertical tail unit consisting of at least two fins (5, 6) and forming a channel (8) together with the rear part (7) of the fuselage (4), which is disposed on the back of same; and at least one turboshaft engine (9, 10) which is disposed on the back of the fuselage (4), such that the gas streams generated by the turboshaft engine (9, 10) enter the channel (8) and such that the downstream noise of the engine (9, 10) is masked laterally and downwardly by said channel. The root sections (11, 12) of the wings (2, 3) are disposed close to the air inlet (15, 16) of the turboshaft engine (9, 10) such that the upstream noise generated thereby is masked laterally and downwardly by said wings (2, 3).

The present invention relates to an aircraft with low noise, such as during take-off and landing.

For example, from the document US-A-3 936 017, there is already known an aircraft comprising:
a fuselage;
two wings disposed laterally with respect to said fuselage and not supporting any engines;
a vertical rear tail unit constituted by at least two fins and forming, with the rear part of said fuselage, a channel disposed on the back of the latter; and
at least one turboshaft engine disposed on the back of said fuselage such that the gas flows generated by said turboshaft engine enter said channel.

Thus, because of the design of the rear tail units in the form of a channel and of the arrangement of the turboshaft engines at the entrance of the channel, it is possible to reduce the downstream noise considerably (that is to say that, essentially, the noise generated towards the rear of the rotary parts of the turboshaft engines and the combustion noise), since that downstream noise is drawn in by the channel and is evacuated along it and upwards away from the fuselage, that is to say away from the passengers situated at the rear of the aircraft's cabin and a fortiori from residents near airports. The downstream noise generated by the turboshaft engines is thus masked by the rear tail units of the fuselage which constitute an acoustic screen.

With regard to the reduction of the upstream noise (that is to say essentially the forward noise generated by the fans of the turboshaft engines), the document US-A-3 936 017 provides, on the one hand, for greatly elongating, in the forward direction, the nacelles of the turboshaft engines and, on the other hand, for placing movable flaps between the wings of the aircraft and said turboshaft engines. Thus, said wings are associated with said movable flaps in order to form a screen to said upstream noise.

It will be noted that such an arrangement is particularly complex and that, in addition, it can be used only for short aircraft because said turboshaft engine nacelles cannot be elongated in an exaggerated manner without harming the aerodynamics of the aircraft and the performance of the turboshaft engines.

The purpose of the present invention is to overcome these disadvantages and to allow the reduction of the upstream noise in a simple and effective manner, even on very long aircraft, in particular during take-off and landing.

For this purpose, according to the invention, the aircraft comprising:
a fuselage;
two wings disposed laterally with respect to said fuselage and not supporting any engines;
a vertical rear tail unit constituted by at least two fins and forming, with the rear part of said fuselage, a channel disposed on the back of the latter; and
at least one turboshaft engine disposed on the back of said fuselage such that the gas flows generated by said turboshaft engine enter said channel and that the downstream noise of said turboshaft engine is masked laterally and downwardly by said channel, is noteworthy in that:
said wings have a reverse sweep, and
the root sections of said wings are disposed close to the air intake of said turboshaft engine such that the upstream noise generated by the latter is masked laterally and downwardly by said wings.

The present invention is based on the fact that, since the wings have a reverse sweep, it is possible, whilst preserving a satisfactory quality of flight (in particular with regard to the position of the aerodynamic center with respect to the center of gravity of the aircraft) to move said wings sufficiently back along the fuselage that they mask said upstream noise of the turboshaft engines.

Furthermore, it will be noted that because of the reverse sweep of its wings, the aircraft has excellent cruise performance, in particular by making use of laminarity techniques.

The figures of the appended drawing will give a good understanding of how the invention can be embodied. In these figures, identical references refer to similar items.

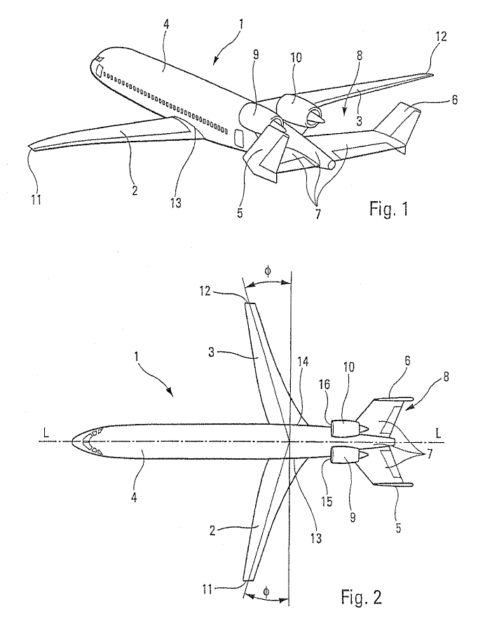

FIG. 1 is a perspective view, from the rear and from above, of an aircraft according to the present invention.

FIG. 2 is a plan view of the aircraft shown in FIG. 1.

The aircraft 1, shown diagrammatically in FIGS. 1 and 2 and according to the present invention, comprises two wings 2 and 3 disposed laterally and symmetrically with respect to the fuselage 4 having a longitudinal axis L-L.

The vertical rear tail unit of the aircraft 1 comprises two fins 5 and 6 forming, with the rear part 7 of the fuselage 4 comprising the horizontal tail unit of the aircraft, a channel 8 disposed on the back of said aircraft. The channel 8 is open in the upward direction, but closed in the downward direction (by said rear part 7) and laterally (by the fins 5 and 6).

Two turboshaft engines 9 and 10 are supported by the back of the fuselage 4 and are disposed such that the gas flows generated by said turboshaft engines enter said channel 8. The latter thus serves as an acoustic screen, which reduces, downwardly and laterally, the downstream noise generated by the turboshaft engines 9 and 10.

Moreover, the wings 2 and 3 have a reverse sweep φ (that is to say that their free ends 11, 12 are farther forward than their wing root sections 13, 14 on the fuselage 4) and said wing root sections 13, 14 occupy a rearward position with respect to said fuselage 4 in such a way as to be disposed close to the air intakes 15, 16 of the turboshaft engines 9, 10. In these conditions, the upstream noise generated by said turboshaft engines 9, 10 is masked laterally and downwardly by the wings 2, 3.

Thus, because of the arrangements described above, the aircraft 1 can be particularly silent, especially during take-off and landing, since the downstream noise and the upstream noise of the turboshaft engines 9, 10 are masked by the tail units 5, 6, 7 and by the wings 2, 3 respectively. Moreover, it performance in cruising flight is excellent because of the reverse sweep of said wings.

1. An aircraft comprising:
a fuselage (4);
two wings (2, 3) disposed laterally with respect to said fuselage (4) and not supporting any engines;
a vertical rear tail unit constituted by at least two fins (5, 6) and forming, with the rear part (7) of said fuselage (4) , a channel (8) disposed on the back of the latter; and
at least one turboshaft engine (9, 10) disposed on the back of said fuselage (4) such that the gas flows generated by said turboshaft engine (9, 10) enter said channel (8) and that the downstream noise of said turboshaft engine (9, 10) is masked laterally and downwardly by said channel, characterized in that:
said wings (2, 3) have a reverse sweep (φ), and
the root sections (13, 14) of said wings (2, 3) are disposed close to the air intake (15, 16) of said turboshaft engine (9, 10) such that the upstream noise generated by the latter is masked laterally and downwardly by said wings (2, 3).
